(19) United States
(12) Patent Application Publication
(10) Pub. No.: US 2006/0170567 A1
(43) Pub. Date: Aug. 3, 2006

(54) Verification of loop sensing devices

(76) Inventor: Michael John Dalgleish, Oxfordshire (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/530,103

(22) PCT Filed: Jun. 30, 2003
(86) PCT No.: PCT/GB03/02817

§ 371 Date: Jul. 19, 2005

(30) Foreign Application Priority Data
Oct. 2, 2002 (GB) 0222010.2

(51) Int. Cl. G08G 1/01

(52) U.S. Cl. 340/933; 340/928

(57) ABSTRACT

A verification apparatus for testing a loop detection system or loop sensor comprises one or more verification loops (222, 203, 223, 204) for placing adjacent the loop sensor (401, 402) and impedance varying means (303, 304) for varying the impedance of the or each verification loop. The change in impedance may be caused to move along the apparatus so as to simulate the passage of a vehicle past the loop sensor.

The present invention relates to the verification and calibration of loop sensing devices and detection systems.

Loop detection systems are often installed in highways for connection to traffic counters and/or classifiers to measure parameters such as vehicle count, speed, and length. The passage of a vehicle is detected by means of a loop sensor, essentially a coil of wire typically about 2 metres by 2 metres in the road surface, connected to an oscillator in a loop detector. When a vehicle passes over the loop sensor coil, the phase or frequency of the oscillation is affected, and this generates a signal in the loop detector which indicates the passage or presence of the vehicle.

At traffic lights, loop sensors are connected to standalone loop detectors to indicate vehicle presence and the speed, length and occupancy ratio of lanes as vehicles approach the lights. More recently, the UK Highways Agency has installed loop sensors to detect traffic patterns and flows on interurban motorways to automatically set signs and take other control actions when the speed and/or flow reaches certain levels.

The theory of loop detection systems is described in GB Patent Publication No. 2149952. Whilst the detail design of loop detectors may vary, this patent describes the method of operation and aspects of detection which broadly speaking applies to most detectors on the market today.

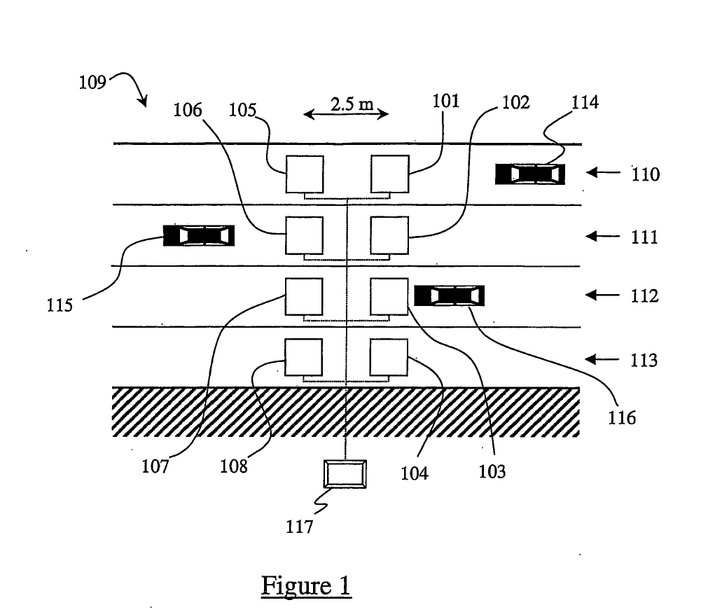

A popular arrangement for loop detection is shown in FIG. 1, which shows eight loop sensors 101-108 arranged in pairs in three traffic lanes 110-112 and the hard shoulder 113 of one carriageway of a dual three lane motorway 109. The loops of each pair are separated by a distance of typically 2.5 m. Signals from the loop sensors are transmitted via feeder cables to a detector unit 117. As a vehicle 114 drives over the sensor in its lane 110, it is detected by two loops 101, 105 in succession.

Since the distance between the loops 101, 105 is known, it is possible to calculate the speed and length of each vehicle 114, 115, 116, in addition to knowing its presence and the lane along which it travels. The speed is calculated by reference to the two leading edges of the signal from the two loops 101, 105 and the distance on the ground between these two loops which is known from the installation records. The length of the vehicle 114, 115, 116 can then be calculated by using the difference in time between the leading and trailing edge of loop 101 and the speed already calculated. The length thus calculated must be reduced by the length of the loop. These calculations can be summarised as follows:

$$Speed = \frac{Distance\_between \_loop \_leading \_edges}{Time\_of \_travel}$$

If the distance is expressed as metres and the time of travel is expressed as seconds, then the speed will be in units of metres per second.
Length=Time_of_occupancy×Speed−Loop_length

If the time of occupancy of a loop is expressed in seconds, the speed in metres per second and the loop length in metres, then the resultant length will be in units of metres.

As will be apparent, the accurate measurement of vehicle speed and length will depend on an accurate knowledge of the fixed dimensions of the loop and the distance between loops in a pair. Moreover, the vehicle path in relation to the loop location needs to be taken into account. If a vehicle approaches and moves over the loops at an angle and/or not directly over the centreline parallel to the side edges of the loop, errors will be introduced. These errors will not be easily apparent from a physical examination of the site, especially since it is not easy with an active highway to go onto the road surface to check these geometric relationships.

Furthermore, if an error was made at the time of loop sensor installation, and one or more loops have the wrong number of turns, then those loops will have differing sensitivities.

In addition to this, the loop detector may also introduce errors. The loop detector “drives” the loop sensor and determines vehicle presence by a phase or frequency shift due to the influence of the vehicle on the characteristics of the loop sensor. In doing so, the loop detector may add its own errors into the system. For example, a loop detector may have a time varying sensitivity as a vehicle moves through the loop sensor area, such that the trailing edge signal from the detector appears earlier than it should due to the shift in threshold as the detector adjusts for long term drift. Such an error will in effect “shorten” the length of the vehicle observed.

In practical situations there may be irregularities in the loop installation and its condition that cannot be revealed even by a detailed inspection, and these irregularities can generate systematic under or over reading of count, vehicle speed and vehicle length. For example, there may be steel reinforcement in the vicinity of one loop of a pair, and not in the other. The depth of the loop below the road surface may vary significantly. The condition of the loop sensor wire and the feeders may vary. There may even be small imperfections in the insulation and hence impedance to ground as a result. Feeders may be mismatched. All of these factors contribute to variability of the performance of the loop detection system in systematic and random ways.

Because of these factors, it is not possible to take just one component of a loop detector system, e.g. the detector itself, and confidently assess the performance of the entire system. If the system is to be properly assessed, it must be assessed as an integrated whole and not just parts. Ideally it should be tested in such a way that is entirely independent of the system under test, and allows any existing application to continue whilst the test is in progress.

A further problem arises with active traffic measures being considered to increase the utility of existing road construction with the deployment of so-called Intelligent Highway Transportation Systems (ITS). In certain scenarios, ITS may manage the running of a highway in such a way that the latitude of inherent safety is potentially reduced unless highly reliable sensors and control algorithms are introduced. For example, in the case of a three or four lane highway, a large increase in capacity can be effected at peak hour by opening the hard shoulder (break-down lane) for normal traffic use, thus creating a 33% or 25% increase in capacity. Before such a lane can be opened, as the peak hour approaches, the lane must be checked for stopped vehicles. In this case a sensor must have a “fail-safe” mode of operation, because it would clearly increase the level of hazard if the lane were to be opened when a vehicle was occupying the hard shoulder or any other emergency area. In these circumstances the detector should have some way of knowing that it is operating correctly, and that the output is valid.

In summary, to properly test and calibrate a loop detection system, comprising sensor, detector and associated processing unit, it is necessary to test and calibrate the entire system, in situ, without making additions or substitutions to the system under test. Further, if the reliability of a sensor output is critical, it is desirable to have some way to automatically validate that output, either detect or not-detect, for operational safety and performance.

GB Patent publication no. 1588531 describes improvements to the art of loop detection by the use of an analyser which provides an output based on phase difference to indicate vehicle presence. GB patent publication no. 2131994 describes techniques for adjusting for climatic conditions and other environmental effects.

GB patent publication no. 2076243 describes an improvement to the oscillator front end to enable oscillators to make a fast start-up, and hence allow more rapid multiplexing of a scanned detector

GB patent publication no. 2140602 describes how the signals from a loop detector can be analysed in a form of “signature analysis” and the vehicle classification (car, truck, bus etc.) be determined.

All of the techniques described in the above publications are concerned with the improvement of the performance of the loop detector circuitry and interpreting the loop sensor signals. Little work has been done on the assessment of these sensor systems which are becoming much more critical in importance as the ITS (Intelligent Transport Systems) market develops.

A US Company, DVP Inc of 2410 Research Boulevard Rockville Md. has developed a loop detector testing device called the ILT II. This device acts as an artificial loop sensor which is connected to a loop detector under test. By setting various parameters in the ILT II, the detector is exercised through a number of inductance, resistance and capacitative values associated with the loop sensor. This system is very useful, especially in the laboratory, but in the field it requires the sensor loop to be disconnected and hence all actual vehicle data during the test is lost. Whilst for some applications this might be acceptable, for the majority of control situations, such as at traffic lights or in a Motorway Incident Detection and Automatic Signalling (MIDAS) inter urban control situation, taking the detection system offline while testing is not possible. In addition the ILT II only validates the detector, not the loop sensor or the loop sensor and the detector in combination.

This testing system therefore fails to test the whole sensor/detector system. There has been little work done and published to improve the test and calibration of whole loop detection systems.

At the present time two methods are known:
Vehicle probe method, using known speed and/or length vehicle fleet
Secondary sensor system, to make independent measurements

In the vehicle probe system, one or more vehicles are equipped to act as “probe” vehicles. These vehicles have some system which enables the speed to be assessed at the point they pass over the detector system sensors and have their length determined from manufacturer's tables of dimensions or physically measured before the test or calibration. Such a system is described in British Patent No. 2377027, whereby the presence and speed of the probe vehicle is determined by a GPS based system.

A disadvantage of this system is that the vehicles which act as probes must be arranged at the expense of the test and calibration authority. If required for just this activity these would typically cost (with driver) around £200 per day for each vehicle. In order to have a reasonable sample of vehicle type, at least 10 vehicles and drivers are required, raising the cost to about £2,000 per day. The number of “runs” which can be made past the site in a day depends on the circuit length, and may be only 15 or 20 in a full day, making the cost of each test sample more than £40.

A secondary sensor system relies on the fact that certain sensors may be more reliable and/or accurate than the primary loop sensor, but only under certain conditions. For example, a Doppler radar device can measure the speed of vehicles with a very high degree of accuracy as long as there is only a single vehicle in the microwave beam, and if the precise location of that vehicle relative to the microwave emitter/receiver is known. The secondary sensor system can therefore take readings when the conditions are satisfied, and these readings can be used to assess the accuracy of the primary sensor. Such a system is described in British Patent Application No. 0217226.0.

When a secondary sensor system is used, the additional measurement system must be procured and permanently installed or brought to site for the test. Often a loop detection system is the most accurate system for the application, and it may be difficult to find a secondary system which is as accurate as the primary system. For example, using a radar speed gun to assess vehicle speed error is difficult because of the cosine effect; the radar gun always reads a lower speed if the vehicle is not heading exactly for the experimenter, who will naturally not be standing directly in the path of the vehicle stream.

It is therefore difficult within a reasonable cost level to test and calibrate loop detectors, sensors and systems.

Loop sensors are also used in static sensor and detector systems, such as used, for example, in the control system of an automatic gate. It is well known that a loop sensor and detector placed in the area where the gate swings open and closed can provide a signal if a vehicle has not cleared the gate, and hence prevent the operation of the gate. This simple use of the loop sensor and detector (the loop detection system) prevents the vehicle from being damaged and/or pedestrians leaving or entering the vehicle being trapped between the vehicle and the gate.

Users might come to rely on such a system, especially when its use is widespread. Should the loop sensor or loop detector fail, then the protection would no longer be ready to act, and as a result the damage or injury referred to above would occur.

What is needed is a system that that would be “fail-safe”. Such a system would detect a failure in the sensor, in any of the connections, or even a gradual reduction in sensitivity of the loop detection system. Such a fail-safe addition would then disarm the automatic opening and set an alarm or warning visible or audible to the owner.

Whilst this automation example has been given, it would be advantageous in many other applications of loop detection systems to know about a total or partial failure of the loop sensor. Since the loop sensor is always in the environment to a greater extent than the detector, often under highway traffic load and exposed to the elements, it is obviously the most likely source of failure or reduction in performance. In addition, many loops “fail” because of accidents or highway works in the vicinity.

In accordance with a first aspect of the present invention there is provided a verification apparatus for the verification of a loop sensor, the apparatus comprising:
a verification loop comprising a loop of electrically conductive material; and
impedance variation means for varying the impedance of the verification loop.

The verification apparatus may be placed near a loop sensor, and the impedance of the verification loop changed. This simulates the presence of a vehicle near the loop sensor, enabling the operator to determine whether the loop sensor (and associated loop detector) is responding to adjacent vehicles in the correct manner.

The impedance variation means may comprise a switch for completing a conducting path around the verification loop.

As described above, traffic detection systems frequently comprise more than one loop sensor arranged in a single lane. For example, a pair of loop sensors may be used to determined the speed and length of vehicles. It is therefore desirable to be able to verify the output of two sensors at the same time, and to be able to simulate a vehicle moving over the sensors, as well as a stationary vehicle in proximity to a loop sensor. A plurality of verification loops may be arranged in a substantially linear array in order to simulate a moving vehicle.

In a preferred embodiment, the verification apparatus comprises two substantially parallel elongate edge conductors and an array of elongate linking conductors. Each linking conductor extends from one edge conductor to the other edge conductor. Each linking conductor is associated with a switch which is actuatable so as to complete a conducting path along that linking conductor from one edge conductor to the other edge conductor. A verification loop may be formed from two adjacent linking conductors and the portions of the edge conductors between the two adjacent linking conductors. Control means are preferably provided for activating and de-activating the switches.

Alternatively or in addition, a switch may be associated with each portion of an edge conductor between two adjacent linking conductors. Thus a verification loop may be completed by activating the switches associated with portions of edge conductors rather than (or in addition to) activating switches associated with linking conductors.

The control means may be arranged to activate and de-activate the switches in sequence in such a way that a complete verification loop comprising a conducting loop effectively moves along the apparatus.

Preferably, the control means is arranged to activate the switches associated with a plurality of adjacent linking conductors (or portions of edge conductors between adjacent linking conductors) simultaneously so as to produce a conducting area, the conducting area including said plurality of adjacent linking conductors and a portion of each of the edge conductors.

The controller is preferably then arranged to activate the switches in sequence in such a way that the conducting area effectively moves along the apparatus.

The or each switch may be actuatable in such a way as to cause the associated linking conductor or portion of edge conductor to become partially conducting, and may comprise a semiconductor. Alternatively or in addition, the conductive material itself may comprise a semiconductor.

In order to place the verification apparatus near the loop sensors to be verified, the verification apparatus may be mounted on a moveable platform.

In accordance with a second aspect of the present invention there is provided a vehicle detection system, comprising a loop sensor, a loop detector for driving the loop sensor and detecting changes in the impedance of the loop sensors and a verification apparatus as described above in proximity to the loop sensor.

The vehicle detection system may comprise more than one loop sensor, the verification apparatus being large enough to be placed adjacent to each loop sensor simultaneously. Alternatively, an additional verification apparatus may be placed in proximity to the additional loop sensor.

Furthermore, it is possible to verify that loop sensors in adjacent lanes correctly identify vehicles straddling lanes. If a vehicle passes two loop sensors in adjacent lanes while straddling those lanes so that a part of the vehicle is in each lane, only one of the loop sensors should record the passage of the vehicle. The verification apparatus described above may be used to simulate the passage of a vehicle straddling two lanes by placing it in the gap between adjacent loop sensors. When the verification apparatus is activated, the detection system should then identify the passage of a single vehicle.

As an extension of this technique, two of the verification apparatuses may be positioned and activated simultaneously over loop sensors in adjacent lanes. The detection system should then report both vehicles synthesised by the apparatus.

In accordance with a third aspect of the present invention there is provided a method of verifying a vehicle detection system, the vehicle detection system comprising a loop sensor and associated loop detector for driving the loop sensor and detecting changes in impedance in the loop sensor, the method comprising:
placing a verification loop adjacent to the loop sensor;
varying the impedance of the verification loop so as to vary the impedance of the loop sensor;
measuring the change in impedance of the loop sensor; and
comparing the change in impedance of the loop sensor with the change expected in response to the known change in impedance of the verification loop.

In accordance with a preferred embodiment of the present invention there is provided a method of verifying a vehicle detection system comprising one or more loop sensors and associated loop detectors for driving said loop sensors and detecting changes in impedance in the loop sensors, the method comprising:
placing a verification apparatus adjacent the loop sensor or sensors, the verification apparatus comprising:
   a pair of substantially parallel elongate edge conductors; and
   an array of elongate linking conductors each extending from one edge conductor to the other edge conductor, each linking conductor being associated with a switch for completing a conducting path along that linking conductor from one edge conductor to the other edge conductor; and
activating the switches in such a way that a plurality of adjacent linking conductors simultaneously have complete conducting paths linking the edge conductors, so as to produce an effective area of conducting material. Preferably the switches are activated in such a way that the effective area moves along the apparatus.

In accordance with a further preferred embodiment of the present invention there is provided a verification apparatus for verifying a loop detection system having at least one loop sensor, the verification apparatus comprising:
at least two substantially parallel elongate edge conductors;
a plurality of elongate linking conductors, each extending from one edge conductor to another edge conductor; and
a plurality of individually addressable switches, each switch being associated with a linking conductor or a portion of an edge conductor between two adjacent linking conductors, for completing a conducting path along the linking conductor or portion of edge conductor.

The switches may alternatively be associated with each edge conductor for completing a conducting path between two adjacent linking conductors, rather than being associated with the linking conductors themselves.

The verification loop described above may thus be in two forms:
A single, switchable “shorted turn” loop which can be positioned over all, or part, of a normal sensor loop
A multiple, switchable series of small “shorted turn” loops positioned over all, or part of a normal sensor loop.

A “shorted turn” loop may be a completed loop of conducting material, or may be an impedance or a signal injected into the verification loop.

A series of conductors are placed in a plane above a loop sensor. When a portion or all of these conductors are “shorted out”, they simulate the presence of a vehicle at that position. A controller may be arranged to “short out” the conductors in a sequence which simulates vehicle movement. The system under test responds normally and generates an output which may be compared with the output expected for the simulated vehicle.

Semi-conductors or a semi-conducting material may be used with a more sophisticated control algorithm which more accurately reflects the analogue nature of the signal from a real vehicle.

Because the entire loop detection system is tested by this independent means, unlike all the earlier methods, this method is more consistent and more accurate in assessing the system under test or calibration.

In a further variation, the operation of the verification loops can be controlled by the loop detector itself, thus simulating vehicles for count, speed, length and other parameters, and hence becoming a highly reliable “self-verifying” loop detector.

A precise number of vehicles each with a known speed and known lengths may be simulated electronically. The loop sensor and detection system under test or calibration can then be assessed precisely, even while in normal operation. Unusual or known problematic vehicles can also be simulated.

Some preferred embodiments of the invention will now be described by way of example only and with reference to the accompanying drawings, in which:

FIG. 1 is a schematic diagram showing the distribution of loop sensors on one carriageway of a two-carriageway motorway;

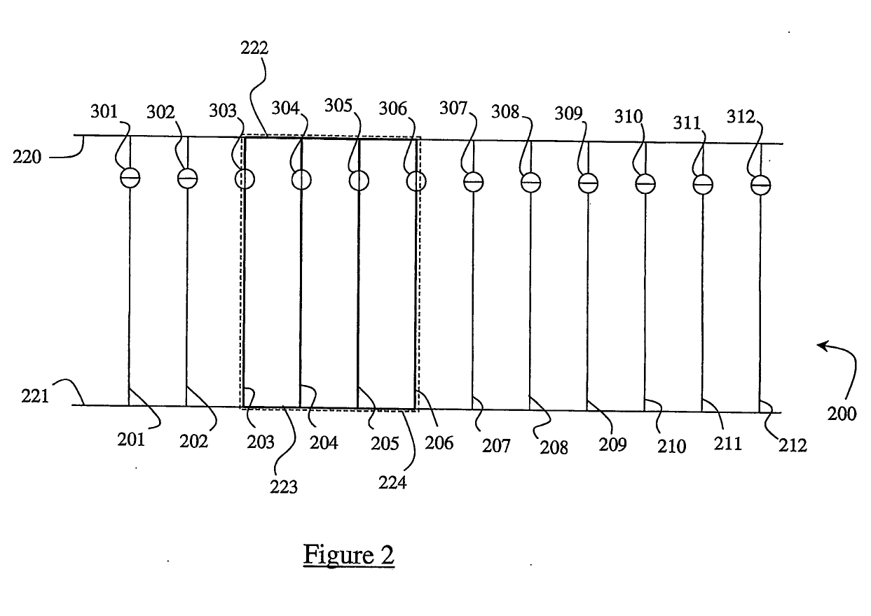

FIG. 2 is a schematic drawing of an array of conductors for verifying a loop sensor;

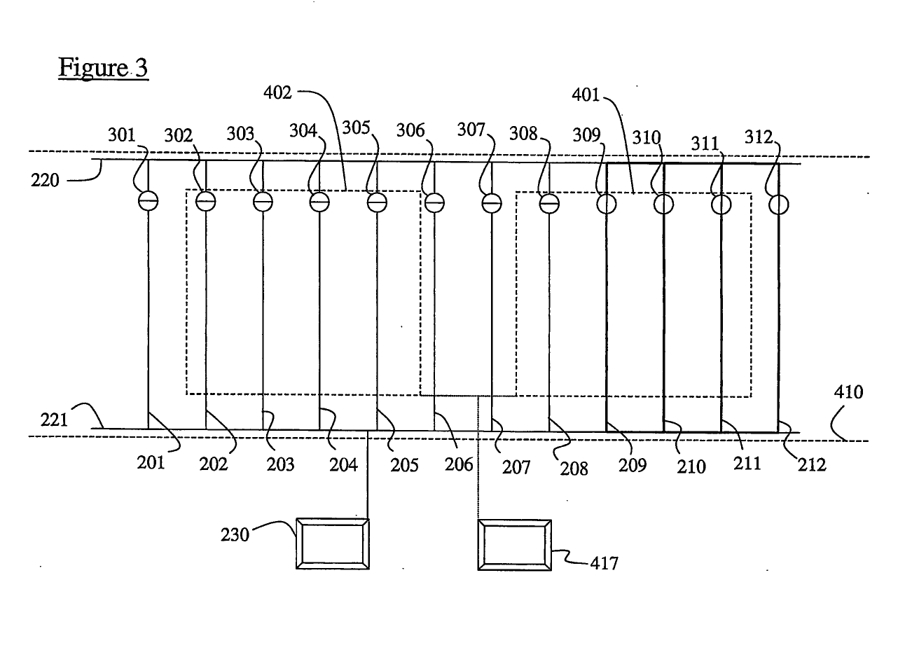

FIG. 3 shows the array of conductors of FIG. 2 connected to a control device and placed over a pair of loop sensors; and

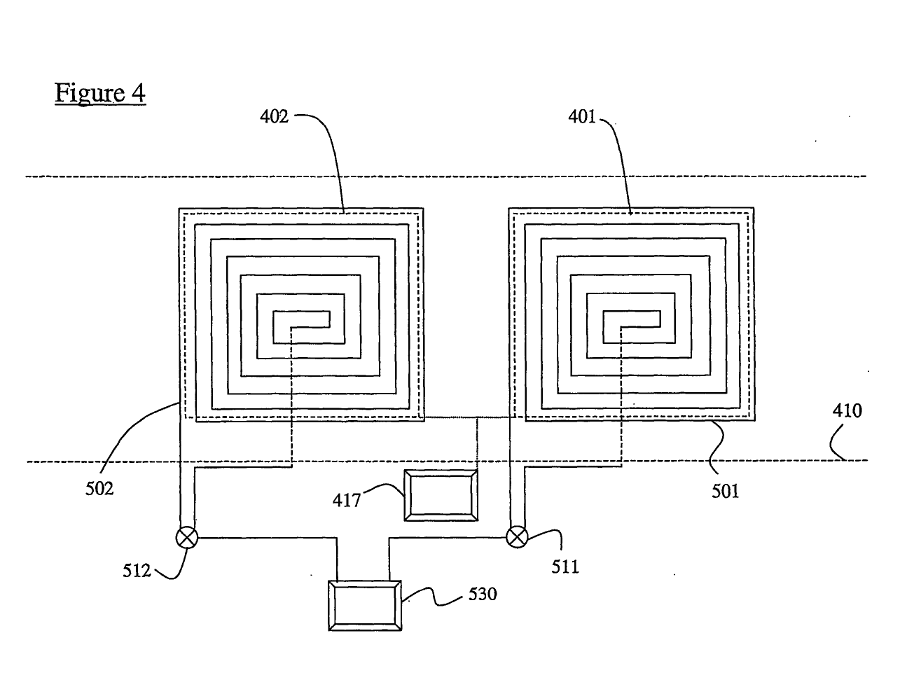

FIG. 4 is a schematic drawing of a pair of coils placed over a pair of loop sensors for verifying the loop sensors.

FIG. 2 shows a verification apparatus 200 for verifying a loop detection system including one or more loop sensors. The verification apparatus 200 includes a pair of elongate, substantially parallel, edge conductors 220, 221. Between the parallel edge conductors is an array of elongate linking conductors 201-212, arranged substantially perpendicular to the edge conductors 220, 221.

Each linking conductor includes a corresponding switch 301-312. When a switch 303 is activated, the conduction path of the associated linking conductor 203 is completed so that the linking conductor 303 forms a conducting path between the edge conductors 220, 221.

If the switches 303, 304 of two adjacent Linking conductors 203, 204 are activated, a complete conducting loop is formed. This loop comprises a portion of one edge conductor 220, a linking conductor 203, a portion of the other edge conductor 221, and the adjacent linking conductor 204. The loop can be considered to be a “shorted turn”, providing a loop of conductive material which would affect the inductance of a loop sensor placed nearby.

It will be appreciated that a similar arrangement can be produced by associating switches with the edge conductors 222, 223 rather than (or in addition to) the linking conductors 201-212. In other words, the activating of switches (not shown) associated with the portions of the edge conductors 222, 223 between two adjacent liking conductors 202, 203 can be used to provide a complete conducting loop including the two adjacent linking conductors. The following discussion describes the operation of the apparatus by reference to switches associated with linking conductors 202-212 only, but it will be appreciated that the use of a series of switches associated with the edge conductors 222, 223 will allow the same effects to be achieved.

If the switches 303, 304, 305, 306 associated with more than two linking conductors 203, 204, 205, 206 are all closed, a “shorted turns area” 224 is formed, comprising linking conductors 203, 204, 205, 206 and edge conductors 222, 223. This “shorted turns area” provides sufficient conducting paths to simulate a continuous sheet of conductive material. When near or directly over a road loop sensor, the shorted turns area will have an effect on the loop sensor similar to that of the metal pan of a vehicle, thus simulating a vehicle located over the loop sensor.

FIG. 3 shows the verification apparatus 200 located over a pair of loop sensors 401, 402 in a roadway 410. The loop sensors 401, 402 are connected to a loop controller device 417. The verification apparatus 200 is connected to a controller device 230 which controls the opening and closing of the switches 301-312. The controller device 230 can be programmed to operate the switches 301-312 in sequence so as to form a shorted turns area which “moves” along above the loop sensors 401, 402. Initially, the four switches 309, 310, 311, 312 are closed so that a shorted turns area is formed at the right hand end of the apparatus. Then switch 312 is opened and switch 308 is closed, so that the shorted turns area moves one conductor to the left. Then switch 311 is opened and 307 is closed, again moving the shorted turns area one conductor to the left. This process is repeated until the shorted turns area has moved all the way along the apparatus

When the controller 230 is programmed appropriately, a vehicle of known speed and length can be simulated by the moving shorted turns area. For example, if a vehicle of speed 10 metres per second and of length 5 metres is to be simulated, then the switching must be arranged to move along the array of linking conductors 201-212 at a speed of 10 metres per second. If the conductors are spaced at 0.5 m intervals, then 10 conductors must be shorted at any time. It is obvious from this explanation to any practitioner how to simulate vehicle of various length and speeds. It is also clear that any desired platoon of vehicles can easily be generated with a suitable controller device.

Thus the known parameters (speed, length, count etc.) of the vehicles simulated by the controller device 230 of the verification apparatus 200 can be compared to the same parameters as measured by the loop controller device 417 via the loop detectors coupled to the loop sensors 401, 402, and thus used to assess the accuracy of the detection system. Furthermore, a statistically useful sample can be taken in a relatively short space of time.

Furthermore, it is possible to verify that loop sensors in adjacent lanes correctly identify vehicles straddling lanes. If a vehicle passes two pairs of loop sensors in adjacent lanes while straddling those lanes so that a part of the vehicle is in each lane, only one of the pairs of loop sensors should record the passage of the vehicle. The verification apparatus described above may be used to simulate the passage of a vehicle straddling two lanes by placing it above the gap between adjacent pairs of loop sensors. When the verification apparatus is activated, the detection system should then identify the passage of only a single vehicle.

As an extension of this technique, two of the verification apparatuses may be positioned and activated simultaneously over loop sensors in adjacent lanes. The detection system should then report both vehicles synthesised by the apparatus.

It will be appreciated that a verification apparatus 200 as described above cannot easily be installed permanently in the roadway above the loop sensors. In order to simulate a vehicle pan, the conductors 201-212 should be a similar height above the loop sensors 401, 402 as would be the base of a vehicle, and conductors at this height cannot be permanently installed without blocking the roadway. It may therefore be necessary to provide a system for temporarily placing a verification apparatus 200 above a loop sensor or pair of loop sensors 401, 402.

In one embodiment, a wooden trailer is constructed of a length equal to the maximum size of the loop sensor array. Typically this would be 2.5 metres wide and 7 metres long. This might be in the form of a four wheel trailer towed behind a truck or car, and with hazard lights to inform approaching vehicles in the lane that they should move to another lane to avoid delay. The trailer is parked over the loops in the lane under test. Note that this method of arrival at the site makes the alignment automatically correct in terms of angle of approach and position in the lane.

A series of conductors are attached within the trailer and low to the ground but within the wooden frame. Switches are arranged under the control of a microprocessor which connects the conductors together in a way which generates the shorted turns area and simulates the passage of one or more vehicles. The switching short-circuits each area to simulate movement of vehicle into and through the loops.

In another embodiment, the switching is achieved by semi-conducting switches, each of which has a programmable impedance to introduce a more gradual introduction of the shorted turns area and hence better simulate the analogue signal which might be expected from a real vehicle.

Since this process of vehicle simulation can simulate 20 or 30 vehicles per minute, a statistically significant sample can be generated in a few minutes, allowing a temporary or “moving” lane closure which reduces the intrusion and requirements for traffic management.

FIG. 4 shows a further embodiment of a verification apparatus 500 for testing loop sensors 401, 402 in a roadway 410. A single coil 501, 502 is placed over each loop sensor 401, 402, and a semi-conducting impedance switch 511, 512 placed at the ends of each coil. With a sophisticated controller 530, a vehicle can be simulated by appropriately timed lowering then rising impedance on each coil 501, 502, thus enabling a more analogue simulation of vehicle motion, presented to the loop sensors 401, 402, with a reduced number of switches compared to the arrangement of FIGS. 2 and 3. This arrangement has the disadvantage that the distance between the loop sensors 401, 402 must be known in advance.

It will be apparent that any of the above described arrangements may be adopted for use with single loops for counting, speed, and occupancy measurements, and with other sensor arrays with two or more loops. Different shapes and arrangements of conductors could also be used to model the effect of unusually shaped vehicles.

The verification apparatus can also be used in the laboratory testing of loop detector systems. In this application, the road loop sensors are scaled in size to be of a size suitable for laboratory use, for example to a 1:10 scale. In this case a typical loop sensor will be 0.2 metres square and, because the inductance is proportional to area, will require 100 (i.e. 10 squared) times as many turns to produce the same inductance to the detector. So a laboratory model of a three turn road loop requires 300 turns.

A verification apparatus similar to those described above may also be used in conjunction with a simple single loop sensor being used to prevent the closing of a gate when a vehicle is located in the closing path of a gate. A “verification loop” is installed in the same slot in the road surface as the loop sensor. The verification loop is similar to the verification apparatus 200 shown in FIG. 2, although it need only have one turn. In other words, it could consist of a single loop of conducting material and a switch to complete the loop, although it will be appreciated that further shorted turns may be needed if there is a long feeder.

A verification controller is installed for controlling the verification system. At periodic intervals, for example every hour or every day, the verification loop is short-circuited by the controller system. Because this will have the effect of suddenly reducing the inductance of the loop sensor, the loop detector will produce an output which is at the same time and of the same duration as the short-circuiting of the verification loop. If the verification controller is prevented from operating when the gate is in operation (i.e. a vehicle is already over the sensing loop), this should have no effect on normal operation of the gate.

The verification controller can check that the detection occurred within a certain time delay, and has the same length as the actuation. Thus, the loop detection system is tested during every predetermined period. If the period is hourly or a similar interval, the chances of the gate being operated when the loop sensor is faulty is very rare.

As an alternative, the verification could occur just before the gate starts to operate, resulting in a short delay, but in effect verifying the sensor loop before each operation. (If a vehicle were already in the loop area, the gate would correctly fail to operate).

As an extension to this application, the verification loop can also be short-circuited with a resistor or inductor which causes a reduction in the effectiveness of the “shorted-turn”. The impedance may be selected to cause an effective change in inductance in the sensing loop only just above the quoted sensitivity of the loop detector. Thus the test will be more precise and confirm that the sensitivity of the detector is as high as required.

It may be required that the loop detector should not operate below a particular level of sensitivity. This may occur, for example, to ensure that the presence of a vehicle would be detected, but not the presence of a bicycle. For such a situation, the verification controller can also place a different impedance across the verification loop terminals to check that actuation of the detector does not occur in these circumstances. This is achieved by determining the impedance which just causes the detection system to indicate detect, and then using a higher impedance. For example, if a 3.5 ohm impedance across the verification loop just causes a detect signal, then a 5.0 ohm impedance can be used for this test. If the loop detection system gives a detect signal when the 5 ohm impedance is applied, the detection system has become more sensitive for a reason which can then be investigated.

It will be apparent to those skilled in the art that the application of a variable impedance according to a particular vehicle type “signature” could also simulate various specific vehicle types in a more sophisticated type of testing.

It will further be apparent that the invention can apply to any situation where the presence, speed, length etc. of vehicles are detected by loop sensors. This may apply to situations such vehicles in front of automatic gates, travelling along a motorway, queuing at traffic lights etc. In addition, loop sensors are widely used at airports to provide information about the location of aeroplanes. It will be appreciated that such loop sensors can be verified using the same system of shorted turns.

Furthermore, it will be appreciated that the invention may also apply to any other situation in which loop sensors are used to detect metal adjacent to the sensor. Examples include proximity sensors in automated systems.

In addition, it will be appreciated that variations from the above described embodiments may still fall with the scope of the invention. For example, the embodiment of FIGS. 2 and 3 has been described with reference to two parallel edge conductors, but more edge conductors may be used, the edge conductors and linking conductors together forming a “mesh” of conducting paths. Individually addressable switches associated with some or all of these conducting paths allow conducting verification loops to be completed, allowing the simulation of different forms of vehicle movement.

1. Verification apparatus for the verification of a loop sensor, the apparatus comprising:
a verification loop comprising a loop of electrically conductive material; and
impedance variation means for varying the impedance of the verification loop.

2. An apparatus as claimed in claim 1, wherein the impedance variation means comprises a switch for completing a conducting path around the verification loop.

3. An apparatus as claimed in claim 1, comprising a plurality of verification loops arranged in a substantially linear array.

4. An apparatus as claimed in claim 3, comprising:
two substantially parallel elongate edge conductors; and
a plurality of elongate linking conductors, each extending from one edge conductor to the other edge conductor;
a plurality of switches, each switch being associated with a linking conductor or a portion of an edge conductor between two adjacent linking conductors, for completing a conducting path along the linking conductor or portion of edge conductor;
wherein a verification loop is formable from two adjacent linking conductors and the portions of the edge conductors between the two adjacent linking conductors.

5. An apparatus as claimed in claim 4, further comprising control means for activating and de-activating the switches.

6. An apparatus as claimed in claim 5, wherein the control means is arranged to activate and de-activate the switches in sequence in such a way that a complete verification loop comprising a conducting loop effectively moves along the apparatus.

7. An apparatus as claimed in claim 5, wherein the control means is arranged to activate the switches associated with a plurality of adjacent linking conductors or portions of edge conductors simultaneously so as to produce a conducting area, said area including said plurality of adjacent linking conductors and a portion of each of the edge conductors.

8. An apparatus as claimed in claim 7, wherein the controller is arranged to activate the switches in sequence in such a way that the conducting area effectively moves along the apparatus.

9. An apparatus as claimed in any of claims 4, wherein the or each switch is actuatable in such a way as to cause the associated linking conductor or portion of edge conductor to become partially conducting.

10. An apparatus as claimed in any of claims 2, wherein the or each switch comprises a semiconductor.

11. An apparatus as claimed in claim 1, wherein the conductive material comprises a semiconductor.

12. An apparatus as claimed in claim 1, mounted on a moveable platform.

13. A vehicle detection system, comprising:
a loop sensor;
a loop detector for driving the loop sensor and detecting changes in the impedance of the loop sensor; and
a verification apparatus as claimed in any preceding claim in proximity to the loop sensor.

14. A vehicle detection system as claimed in claim 13, further comprising more than one loop sensor, wherein the verification apparatus is placed adjacent to each loop sensor simultaneously.

15. A vehicle detection system as claimed in claim 13, further comprising an additional loop sensor, and an additional verification apparatus in proximity to the additional loop sensor.

16. A vehicle detection system as claimed in claim 13, further comprising two adjacent loop sensors, wherein the verification apparatus is placed in the gap between the two adjacent loop sensors.

17. A vehicle detection system as claimed in claim 16, arranged to verify that, when the verification apparatus is activated, only one of the two adjacent loop sensors detects the passage of a vehicle.

18. A method of verifying a vehicle detection system, the vehicle detection system comprising a loop sensor and associated loop detector for driving the loop sensor and detecting changes in impedance in the loop sensor, the method comprising:
placing a verification loop adjacent to the loop sensor;
varying the impedance of the verification loop so as to vary the impedance of the loop sensor;
measuring the change in impedance of the loop sensor; and
comparing the change in impedance of the loop sensor with the change expected in response to the known change in impedance of the verification loop.

19. A method of verifying a vehicle detection system comprising one or more loop sensors and associated loop detectors for driving said loop sensors and detecting changes in impedance in the loop sensors, the method comprising:
placing a verification apparatus adjacent the loop sensor or sensors, the verification apparatus comprising:
a pair of substantially parallel elongate edge conductors; and
an array of elongate linking conductors each extending from one edge conductor to the other edge conductor, each linking conductor being associated with a switch for completing a conducting path along that linking conductor from one edge conductor to the other edge conductor; and
activating the switches in such a way that a plurality of adjacent linking conductors simultaneously have complete conducting paths linking the edge conductors, so as to produce an effective area of conducting material.

20. A method of verifying a vehicle detection system comprising one or more loop sensors and associated loop detectors for driving said loop sensors and detecting changes in impedance in the loop sensors, the method comprising:
placing a verification apparatus adjacent the loop sensor or sensors, the verification apparatus comprising:
a pair of substantially parallel elongate edge conductors;
an array of elongate linking conductors each extending from one edge conductor to the other edge conductor; and
an array of switches associated with each edge conductor for completing a conducting path along the edge conductor between two adjacent linking conductors; and
activating the switches in such a way as to complete a conducting path along a portion of each edge conductor contacting a plurality of adjacent linking conductors, so as to produce an effective area of conducting material.

21. A method as claimed in claim 19, further comprising activating the switches in such a way that the effective area moves along the verification apparatus.

22. A verification apparatus for verifying a loop detection system having at least one loop sensor, the verification apparatus comprising:
at least two substantially parallel elongate edge conductors;
a plurality of elongate linking conductors, each extending from one edge conductor to another edge conductor; and
a plurality of individually addressable switches, each switch being associated with a linking conductor or a portion of an edge conductor between two adjacent linking conductors, for completing a conducting path along the linking conductor or portion of edge conductor.

23. A verification apparatus for verifying a loop detection system having at least one loop sensor, the verification apparatus comprising:
a pair of substantially parallel elongate edge conductors; and
an array of elongate linking conductors each extending from one edge conductor to the other edge conductor, each linking conductor being associated with a switch for completing a conducting path along that linking conductor from one edge conductor to the other edge conductor.
